(19) United States
(12) Patent Application Publication
(10) Pub. No.: US 2018/0306250 A1
(43) Pub. Date: Oct. 25, 2018

(54) RELEASE BEARING

(71) Applicant: Schaeffler Technologies AG & Co. KG, Herzogenaurach (DE)

(72) Inventors: Steffen Breun, Schweinfurt (DE); Ernst Masur, Untereuerheim (DE); Eugen Domert, Schweinfurt (DE)

(73) Assignee: Schaeffler Technologies AG & Co. KG, Herzogenaurach (DE)

(21) Appl. No.: 15/768,072

(22) PCT Filed: Sep. 5, 2016
(86) PCT No.: PCT/DE2016/200415

§ 371 Date: Apr. 13, 2018

(30) Foreign Application Priority Data
Oct. 19, 2015 (DE) 10 2015 220 266.6

(51) Int. Cl. F16D 23/14

(52) U.S. Cl. CPC F16D 23/146; F16C 33/585

(57) ABSTRACT

Release bearings for actuating a clutch are provided, and may include a bearing ring arranged non-rotatably on a sliding sleeve mounted on a transmission input shaft and a rotatable bearing ring, which interacts with a spring of the clutch. A row of rolling elements may be arranged radially between the two bearing rings and have pressure lines oriented obliquely with respect to a bearing longitudinal axis. The rolling elements may each be bodies of revolution with a circular-arc-shaped generatrix, wherein a center angle between radii bounding the circular-arc-shaped generatrix is smaller than 180°. The non-rotatable bearing ring may have a raceway shaped complementary to a shape of the rolling elements and may guide the rolling elements in an axial direction. The rotatable bearing ring may have a raceway shaped as a spherical surface with a sphere radius corresponding to the generatrix of the rolling elements.

### CROSS-REFERENCE TO RELATED APPLICATIONS

This application is the U.S. National Phase of PCT Appln. No. PCT/DE2016/200415 filed Sep. 5, 2016, which claims priority to DE DE102015220266.6 filed Oct. 19, 2015, the entire disclosures of which are incorporated by reference herein.

### TECHNICAL FIELD

The disclosure relates to a release bearing for actuating a clutch, e.g. a starting clutch of a motor vehicle having a manual transmission.

### BACKGROUND

The purpose of a release bearing is to transmit a linear adjusting movement actuated a clutch pedal, for example, to a rotating element of the clutch. It may comprise a non-rotatable bearing ring arranged on a sliding sleeve mounted non-rotatably on a transmission input shaft, a rotatable bearing ring interacting with a diaphragm spring or similar of the clutch, which applies the coupling force, and a plurality of rolling elements arranged radially between the two bearing rings. By the adjusting movement of the sliding sleeve, the diaphragm spring, which presses a clutch disk connected to the transmission input shaft against a flywheel connected to the crankshaft of an engine, is raised from the clutch disk, i.e. the clutch is released. The diaphragm springs generally include an annular disk with radially inward-pointing spring tongues, with which the rotatable bearing ring interacts in respect of the actuation of the clutch.

Owing to manufacturing and assembly tolerances, there can be geometric errors in the clutch system which lead to uneven load distribution when the clutch is actuated, especially in the preloaded release bearing. On the one hand, this results in uneven contact force distribution between the pressure plate and the clutch disk, leading to grabbing of the clutch. On the other hand, there is a tilting load on the release bearing and accordingly also on the actuating elements associated with the release bearing (hydraulic or pneumatic actuator, actuating fork). This tilting load can disrupt the operation both of the release bearing and the associated actuating devices and may lead to the failure thereof.

DE 199 12 432 B4 discloses a release bearing that is designed as an angular contact ball bearing with pressure lines of the rolling elements which are oriented obliquely with respect to the bearing longitudinal axis to enable the required axial force for the release operation to be transmitted. The inner bearing ring is designed as a non-rotatable bearing ring connected to the sliding sleeve, and the outer bearing ring is designed as a rotatable bearing ring that interacts with the diaphragm spring. In order to compensate for the geometric errors described above, the outer bearing ring is embodied in two parts, namely a first ring, which forms a raceway for the rolling elements, and a second ring, which is connected to said first ring via cap-shaped spherical surface segments, interacts with the diaphragm spring and can be tilted relative to the first ring. In this way, a reaction force that is tilted with respect to the bearing longitudinal axis and acts on the rotatable bearing ring can be compensated. However, this release bearing is very complex in terms of design and manufacture and takes up a relatively large amount of installation space, particularly because of the two ring segments forming the rotatable outer bearing ring.

### SUMMARY

Given this situation, it is an object of the disclosure to provide a release bearing which is simple in terms of design and manufacture and does not require a particularly large amount of installation space in comparison with conventional release bearings.

This object is achieved by the features disclosed herein, while additional embodiments and developments of the disclosure are also disclosed.

The disclosure is based on the insight that it should be possible to achieve the above-indicated characteristics with a rolling bearing which, on the one hand, has the characteristics of a simple single-row angular contact ball bearing and, on the other hand, has the characteristics of a, generally, double-row spherical roller bearing.

Accordingly, the disclosure proceeds from a release bearing for actuating a clutch, e.g. a starting clutch of a motor vehicle having a manual transmission, having a non-rotatable bearing ring arranged on a sliding sleeve mounted on the transmission input shaft, having a rotatable bearing ring, which interacts with a diaphragm spring or similar of the clutch, having a row of rolling elements, which are arranged radially between the two bearing rings and have pressure lines oriented obliquely with respect to the bearing longitudinal axis, and having means for compensating a reaction force, which is tilted relative to the bearing longitudinal axis and acts on the rotatable bearing ring.

To achieve the stated object, provision is furthermore made in this release bearing for the rolling elements each to be in the form of bodies of revolution with a circular-arc-shaped generatrix, wherein the center angle between the radii bounding the circular-arc-shaped generatrix is smaller than 180°, for the non-rotatable bearing ring to have a raceway which is adapted in complementary fashion to the shape of the rolling elements and which guides the rolling elements in the axial direction, and for the rotatable bearing ring to have a race-way which is adapted to the shape of the rolling elements and which is in the form of a spherical surface with a sphere radius corresponding to the generatrix of the rolling elements.

To clarify that the rolling elements are not balls, the following may be stated:
if two arbitrary points are defined on a circle and these points are joined by lines to the center of the circle, then two circle sectors or circular sectors separated from each other by the lines are obtained. In other words, this means that the lines, which are no different from radii, form two circular sectors. The circular curve radially delimiting the respective circular sector is referred to as a circular arc, and the angle between the two radii is referred to as the central angle. If this central angle is less than 180°, the associated circular arc never describes a semicircle.

This single-row release bearing ensures that the overall volume thereof does not exceed that of conventional angular contact ball bearings, and therefore existing clutches can be fitted without modification with the release bearing according to the present disclosure. The oblique positioning of the pressure lines of the rolling elements allows sufficient capacity to absorb axial forces for the envisaged role in clutches. The design of the rolling elements as bodies of revolution with a circular-arc-shaped generatrix and of the rotatable bearing ring with a raceway adapted to the shape of the rolling elements, in the form of a spherical surface with a sphere radius corresponding to the generatrix of the rolling elements, allows a tilting movement of the rotatable bearing ring relative to the non-rotatable bearing ring and hence adaptation to possibly tilted reaction forces, as already explained above.

The release bearing according to the disclosure is furthermore simple in terms of design and manufacture and is therefore inexpensive to produce.

According to an embodiment of the disclosure, it is envisaged that the rolling elements have the shape of a barrel roller, wherein the inner bearing ring is designed as a non-rotatable bearing ring having a raceway that guides the rolling elements axially, and the outer bearing ring is designed as a rotatable bearing ring having a raceway in the form of a hollow sphere. The outer bearing ring interacts with the diaphragm spring of the clutch and compensates for any misalignments of the diaphragm spring by a tilting movement relative to the inner bearing ring.

According to another embodiment of the disclosure, the rolling elements have the shape of a waisted roller, wherein, in this case, the outer bearing ring is designed as a non-rotatable bearing ring having a raceway that guides the rolling elements axially, and the inner bearing ring is designed as a rotatable bearing ring having a spherical raceway. In this case, the function of the inner bearing ring, on the one hand, and of the outer bearing ring, on the other hand, are interchanged relative to the illustrative embodiment described above, i.e. the inner bearing ring interacts with the diaphragm spring of the clutch and compensates for any misalignments thereof.

According to the disclosure, the pressure lines of the rolling elements form a relatively large, steep angle, such as an angle of between 75° and 85°, preferably of 80°, with the bearing longitudinal axis in order to minimize frictional effects between the rolling elements and the associated raceways which occur at shallower angles.

Another embodiment of the disclosure envisages that the possible tilting angle of the respective rotatable bearing ring relative to the non-rotatable bearing ring is limited by stoppers. The stoppers may be formed by circlips arranged on the outer circumference of the inner bearing ring and/or on the inner circumference of the outer bearing ring, as will be explained below by illustrative embodiments.

The disclosure envisages that the release bearing may be permanently lubricated and is therefore sealed off on both axial sides by sealing ring washers, which are each mounted in a fixed manner on one of the bearing rings by one circumferential edge and rest sealingly on the other bearing ring with the other circumferential edge. The contact surface of the sealing ring washers is designed in such a way that sealing is ensured in all tilting positions of the rotatable bearing ring.

Another embodiment envisages that the stoppers are formed by a single component, namely a retaining ring, one end of which is connected to one of the bearing rings in a manner which prevents relative rotation and translation and the other end of which is coupled to the other bearing ring in a manner which is subject to play and allows degrees of freedom in the axial and radial directions.

### BRIEF DESCRIPTION OF THE DRAWINGS

The disclosure is explained in greater detail below by a number of illustrative embodiments. For this purpose, a drawing is attached to the description. In the drawing:

FIG. 1 shows an axial partial section through a release bearing having a barrel roller, in a tilted position,

FIGS. 2a-2b shows a release bearing according to FIG. 1 in different tilted positions on a reduced scale,

FIG. 3 shows a release bearing approximating to that in FIG. 1 having waisted rollers as rolling elements, and

FIG. 4 shows a release bearing approximating to that in FIG. 1 having a retaining ring.

### DETAILED DESCRIPTION

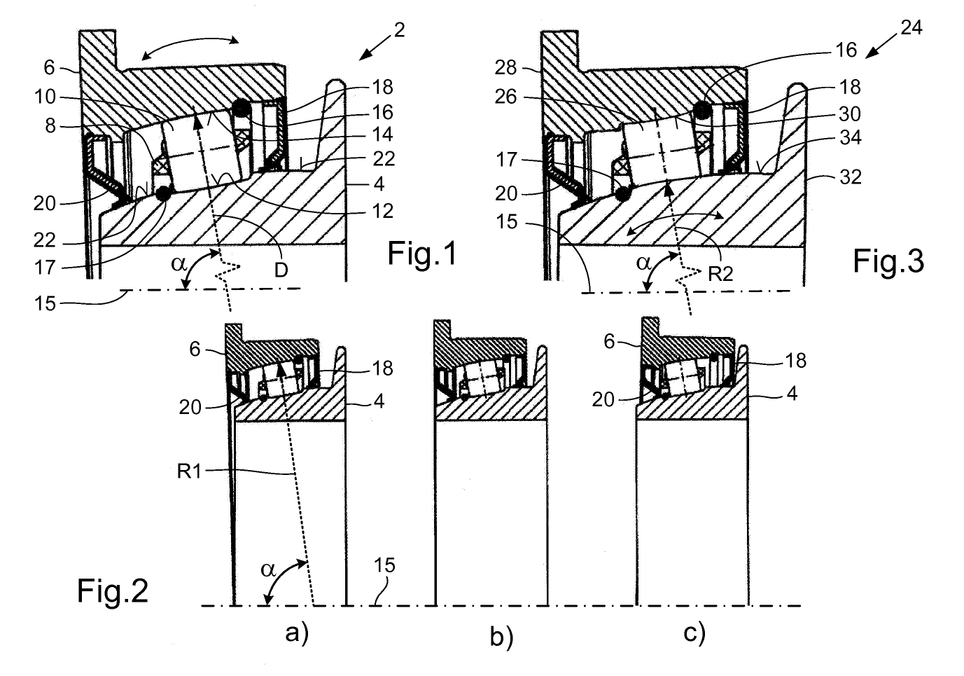

The release bearing 2 illustrated in FIG. 1 comprises an inner bearing ring 4, which is arranged non-rotatably on a sliding sleeve (not shown), an outer bearing ring 6, which is rotatable relative to the inner bearing ring and interacts with a diaphragm spring (not shown) of a clutch, and rolling elements 10, which are arranged between the two bearing rings 4, 6 and are guided in a cage 8. The rolling elements 10, which are designed as “barrel rollers” in the present illustrative embodiment, roll, on the one hand, on a raceway 12, which is formed on the inner bearing ring 4, guides the rolling elements 10 axially and has a concave cross-sectional profile adapted to the barrel shape of the rolling elements. On the other hand, they roll on a hollow-spherical raceway 14, which is formed on the inner circumference of the outer bearing ring 6 and the radius R1 of which with respect to the longitudinal axis 15 of the bearing corresponds to the generatrix that defines the barrel shape of the rolling elements. The pressure line D of the rolling elements 10 forms an angle α of about 80° with the longitudinal axis 15 of the release bearing 2.

During operation, the rotating outer bearing ring 6 can be tilted relative to the inner bearing ring 4. FIG. 1 shows the outer bearing ring 6 in an end position tilted to the left. This end position is determined by a circlip 16, which is arranged on the inner circumference of the outer bearing ring 6 and serves as a stopper. A circlip 17 arranged on the outer circumference of the inner bearing ring 4 delimits the raceway 12 thereof axially at the side.

In order to be able to design the release bearing 2 as a permanently lubricated bearing, it is sealed off on both axial sides by the sealing ring washers 18, 20, which are each mounted in a fixed manner on the rotating outer bearing ring 6 by their outer circumferential edge and rest sealingly on the non-rotatable inner bearing ring 4 by their inner circumferential edge. The contact surface 22 present on the inner bearing ring 6 is designed and dimensioned in such a way that the sealing rings 18, 20 make contact in every tilted position of the outer bearing ring 6 while providing full sealing, as can be seen in FIG. 1.

FIG. 2 shows the release bearing 2 according to FIG. 1 in various tilted positions, namely in an end position tilted to the left in FIG. 2a, in an un-tilted central position in FIG. 2b and in an end position tilted to the right in FIG. 2c. In particular, FIG. 2 also shows that the sealing ring washers 18, 20 rest against the associated contact surface 22 formed on the outer circumference of the inner bearing ring 4 in each of the tilted positions while providing full sealing.

FIG. 3 shows an embodiment of a release bearing 24 according to the disclosure in which the rolling elements 26 have the shape of a waisted roller. On the one hand, they roll on a raceway 30, which is formed on the outer bearing ring 28, guides the rolling elements axially and has a convex cross-sectional profile adapted to the shape of the rolling elements 26. On the other hand, the waisted rolling elements 26 roll on a raceway 34 in the form of a spherical surface, which is formed on the outer circumference of the inner bearing ring 32 and the radius R2 of which with respect to the longitudinal axis 15 of the release bearing 24 is equal to the radius of the generatrix that determines the shape of the contact surface of the rolling elements 26. In the illustrative embodiment according to FIG. 3, the outer bearing ring 28 is preferably designed as a bearing ring connected non-rotatably to a sliding sleeve, and the inner bearing ring 32 is designed as a rotating bearing ring which interacts with a diaphragm spring.

The circlips 16, 17 for limiting the tilting movement of the inner bearing ring 32 and the sealing ring washers 18, 20 at the axial ends for sealing off the release bearing 24 correspond to the elements described with reference to FIG. 1 and therefore do not need to be described again.

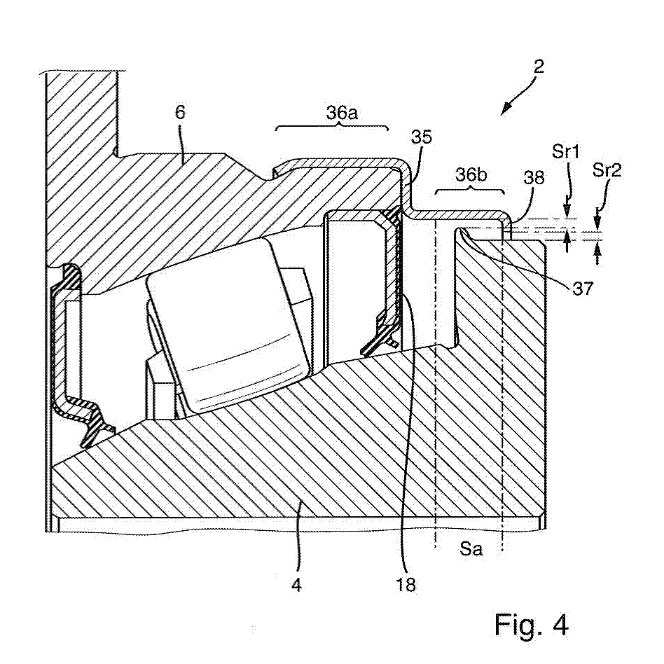

FIG. 4 shows an embodiment of a release bearing 2 according to FIG. 1 with bearing rings 4, 6 that are not tilted relative to one another, although the circlips 16, 17, which may be laborious to install, have been omitted. Instead, the release bearing 2 is held together in a very simple manner until it is installed as intended between the transmission and the internal combustion engine of a motor vehicle by just a single component, namely a retaining ring 35. This retaining ring 35 is pressed onto the outer circumference of the outer bearing ring 6 by its first end 36a in such a way as to be secure against relative rotation and translation. A shoulder 37, which extends in the radial direction, is provided on the other, inner bearing ring 4. The free edge 38 of the second end 36b of the retaining ring 35 is angled radially inward, wherein, in the installed state and without the two bearing rings 4, 6 being tilted relative to one another, the free edge 38 retains an axial play Sa relative to the shoulder 37 and the second end 36b and the free edge 38 retain a radial play Sr1 relative to the shoulder 37 and a radial play Sr2 relative to the inner bearing ring, respectively. This retention of axial and radial play Sa, Sr1, Sr2 ensures that the inner bearing ring 4 is coupled to the outer bearing ring 6 by the retaining ring 35 and that, despite this coupling, the two bearing rings 4, 6 can tilt relative to one another without hindrance. Moreover, this retention of play Sa, Sr1, Sr2 between the free end 36b and the free edge 38 relative to the shoulder 37 and to the inner bearing ring 4, respectively, leads to the formation of a gap or preliminary seal, thereby keeping coarse contaminants away from the sealing washer 18 and therefore prolonging the ability to function thereof.

### REFERENCE SIGNS

2 release bearing
4 inner bearing ring
6 outer bearing ring
8 cage
10 rolling elements
12 raceway on the inner bearing ring 4
14 raceway on the outer bearing ring 6
15 longitudinal axis of the release bearing
16 circlip
17 circlip
18 sealing ring washer
20 sealing ring washer
22 contact surface
24 release bearing
26 rolling elements
28 outer bearing ring
30 raceway on the outer bearing ring 28
32 inner bearing ring
34 raceway on the inner bearing ring 32
35 retaining ring
36a,b end
37 shoulder
38 free edge
α angle of the pressure line
D pressure line
R1 radius
R2 radius
Sa axial play
Sr1,2 radial play

1. A release bearing for actuating a clutch, comprising:
a bearing ring, which is arranged non-rotatably on a sliding sleeve mounted on a transmission input shaft,
a rotatable bearing ring, which interacts with a spring of the clutch,
a row of rolling elements, which are arranged radially between the two bearing rings and have pressure lines oriented obliquely with respect to a bearing longitudinal axis,
wherein the release bearing is configured to compensate for a reaction force, which is tilted relative to the bearing longitudinal axis and acts on the rotatable bearing ring,
wherein the rolling elements are each in the form of bodies of revolution with a circular-arc-shaped generatrix, wherein a center angle between radii bounding the circular-arc-shaped generatrix is smaller than 180°,
wherein the non-rotatable bearing ring has a raceway which is adapted in complementary fashion to a shape of the rolling elements and which guides the rolling elements in an axial direction, and
wherein the rotatable bearing ring has a raceway which is adapted to the shape of the rolling elements and which is in the form of a spherical surface with a sphere radius corresponding to the generatrix of the rolling elements.

2. The release bearing as claimed in claim 1, wherein the rolling elements have a shape of a barrel roller, wherein an inner bearing ring is designed as the non-rotatable bearing ring having a raceway that guides the rolling elements axially, and an outer bearing ring is designed as the rotatable bearing ring having a raceway in the form of a hollow sphere.

3. The release bearing as claimed in claim 1, wherein the rolling elements have a shape of a waisted roller, wherein an outer bearing ring is designed as the non-rotatable bearing ring having a raceway that guides the rolling elements axially, and an inner bearing ring is designed as the rotatable bearing ring having a spherical raceway.

4. The release bearing as claimed in claim 1, wherein the pressure lines of the rolling elements form an angle α of between 75° and 85° with the bearing longitudinal axis.

5. The release bearing as claimed in claim 4, wherein the pressure lines of the rolling elements form an angle α of 80° with the bearing longitudinal axis.

6. The release bearing as claimed in claim 1, wherein a possible tilting angle of the rotatable bearing ring relative to the non-rotatable bearing ring is limited by a stopper.

7. The release bearing as claimed in claim 6, wherein the stopper is formed by circlips arranged on an outer circumference of the bearing ring or on an inner circumference of the outer rotatable bearing ring.

8. The release bearing as claimed in claim 1, wherein the release bearing is sealed off on both axial sides by sealing ring washers, which are each mounted in a fixed manner on one of the bearing rings by one circumferential edge and rest sealingly on the other bearing ring with the other circumferential edge.

9. The release bearing as claimed in claim 6, wherein the stopper is formed by a retaining ring, a first end of which is connected to one of the two bearing rings in a manner which prevents relative rotation and translation and a second end of which is coupled to the other bearing ring in a manner which is subject to play and allows degrees of freedom in axial and radial directions.

10. A release bearing for actuating a clutch, comprising:
a bearing ring arranged non-rotatably on a sliding sleeve mounted on a transmission input shaft;
a rotatable bearing ring, which interacts with a spring of the clutch;
a row of rolling elements arranged radially between the two bearing rings and having pressure lines oriented obliquely with respect to a bearing longitudinal axis;
the rolling elements each being bodies of revolution with a circular-arc-shaped generatrix, wherein a center angle between radii bounding the circular-arc-shaped generatrix is smaller than 180°;
the non-rotatable bearing ring having a raceway shaped complementary to a shape of the rolling elements and which guides the rolling elements in an axial direction; and
the rotatable bearing ring having a raceway shaped as a spherical surface with a sphere radius corresponding to the generatrix of the rolling elements.

11. The release bearing as claimed in claim 10, wherein the rolling elements have a shape of a barrel roller, wherein an inner bearing ring is designed as the non-rotatable bearing ring having a raceway that guides the rolling elements axially, and an outer bearing ring is designed as the rotatable bearing ring having a raceway in the form of a hollow sphere.

12. The release bearing as claimed in claim 10, wherein the rolling elements have a shape of a waisted roller, wherein an outer bearing ring is designed as the non-rotatable bearing ring having a raceway that guides the rolling elements axially, and an inner bearing ring is designed as the rotatable bearing ring having a spherical raceway.

13. The release bearing as claimed in claim 10, wherein the pressure lines of the rolling elements form an angle α of between 75° and 85° with the bearing longitudinal axis.

14. The release bearing as claimed in claim 13, wherein the pressure lines of the rolling elements form an angle α of 80° with the bearing longitudinal axis.

15. The release bearing as claimed in claim 10, wherein a possible tilting angle of the rotatable bearing ring relative to the non-rotatable bearing ring is limited by a stopper.

16. The release bearing as claimed in claim 15, wherein the stopper is formed by circlips arranged on an outer circumference of the bearing ring or on an inner circumference of the rotatable bearing ring.

17. The release bearing as claimed in claim 10, wherein the release bearing is sealed off on both axial sides by sealing ring washers, which are each mounted in a fixed manner on one of the bearing rings by one circumferential edge and rest sealingly on the other bearing ring with the other circumferential edge.

18. The release bearing as claimed in claim 15, wherein the stopper is formed by a retaining ring, a first end of which is connected to one of the two bearing rings in a manner which prevents relative rotation and translation and a second end of which is coupled to the other bearing ring in a manner which is subject to play and allows degrees of freedom in axial and radial directions.
